(19) United States
(12) Patent Application Publication
(10) Pub. No.: US 2016/0099100 A1
(43) Pub. Date: Apr. 7, 2016

(54) CHIP COMPONENT AND MANUFACTURING METHOD THEREOF

(71) Applicant: SAMSUNG ELECTRO-MECHANICS CO., LTD., Suwon-Si (KR)

(72) Inventors: Yong Sun PARK, Suwon-Si (KR); Yun Suk OH, Suwon-Si (KR); Young Dae CHOI, Suwon-Si (KR)

(21) Appl. No.: 14/669,915

(22) Filed: Mar. 26, 2015

(30) Foreign Application Priority Data
Oct. 2, 2014 (KR) 10-2014-0133526

(51) Int. Cl. H01F 27/28; H01F 41/04

(52) U.S. Cl. CPC H01F 27/2804; H01F 41/041; H01F 2027/2809

(57) ABSTRACT

There are provided a chip component and a manufacturing method thereof. The chip component includes: a ceramic body including a plurality of ceramic layers, each of which including external electrode patterns provided by filling intagliated recess portions with a conductive material, the intagliated recess portions being disposed to be spaced apart from one another; an internal coil unit positioned within the ceramic body and including internal conductive patterns disposed on the plurality of ceramic layers; and external electrodes, each of which is provided by connecting the external electrode patterns to each other.

### CROSS-REFERENCE TO RELATED APPLICATION

This application claims the priority and benefit of Korean Patent Application No. 10-2014-0133526 filed on Oct. 2, 2014, with the Korean Intellectual Property Office, the disclosure of which is incorporated herein by reference.

### BACKGROUND

The present disclosure relates to a chip component and a manufacturing method thereof.

An inductor, a multilayer chip component, is a passive element typically forming an electronic circuit, together with a resistor and a capacitor to cancel noise, or is used as a component to form an LC resonance circuit.

Multilayer inductors, which have recently been applied to a wide range of devices, have a structure in which a plurality of ceramic layers, each having an internal coil pattern formed thereon are stacked, and here, the internal coil patterns are connected to each other to form a coil structure to realize desired characteristics such as intended degrees of inductance and impedance.

However, a related art bottom surface electrode inductor requires an additional process of connecting portions of internal electrodes, which are not exposed after being printed, through a via or forming an extra external electrode.

### RELATED ART DOCUMENT

(Patent Document 1) Japanese Patent Laid-Open Publication No. 2010-165973

### SUMMARY

An aspect of the present disclosure may provide a chip component in which external electrodes are formed simultaneously when ceramic layers are stacked, without having to perform an extra process to form the external electrodes, and a manufacturing method thereof.

According to an aspect of the present disclosure, a chip component may include: a ceramic body including a plurality of ceramic layers, each of which including external electrode patterns provided by filling intagliated recess portions with a conductive material, the intagliated recess portions being disposed to be spaced apart from one another; an internal coil unit positioned within the ceramic body and including internal conductive patterns disposed on the plurality of ceramic layers; and external electrodes, each of which is provided by connecting the external electrode patterns to each other.

According to another aspect of the present disclosure, a chip component may include: a ceramic body including a plurality of ceramic layers having intagliated recess portions which are disposed to be spaced apart from one another; and a conductive material filling the intagliated recess portions, wherein a depth of each of the intagliated recess portions is less than a thickness of each of the ceramic layers, and a plurality of external electrode patterns provided by filling the intagliated recess portions with the conductive material are connected through one or more vias penetrating through the plurality of ceramic layers.

According to another aspect of the present disclosure, a method for manufacturing a chip component may include: preparing a plurality of ceramic layers having intagliated recess portions which are disposed to be spaced apart from one another; filling the intagliated recess portions with a conductive material; and forming a plurality of external electrode patterns by filling the intagliated recess portions disposed on each of the plurality of ceramic layers with a conductive material and connecting the external electrode patterns to each other.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view illustrating a chip component according to an exemplary embodiment of the present disclosure such that an internal coil unit appears;

FIGS. 2A and 2B are views illustrating a ceramic layer having an external electrode pattern among components of the chip component according to an exemplary embodiment of the present disclosure;

FIGS. 3A and 3B are views illustrating a ceramic layer illustrated in FIGS. 2A and 2B having an internal conductive pattern and a conductive material;

FIG. 4 is an exploded perspective view of the chip component illustrated in FIG. 1;

FIG. 5 is a perspective view illustrating a chip component according to another exemplary embodiment of the present disclosure such that an internal coil unit appears;

FIGS. 6A through 6H are exploded perspective views of the chip component illustrated in FIG. 5;

FIG. 7 is a flowchart illustrating a method for manufacturing a chip component according to an exemplary embodiment of the present disclosure; and

FIGS. 8A through 8C are views specifically illustrating a method for forming external electrodes in a method for manufacturing the chip component illustrated in FIG. 7.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

### Chip Component

Hereinafter, a chip component according to an exemplary embodiment of the present disclosure will be described, and in particular, a multilayer inductor will be described, but the present inventive concept is not limited thereto.

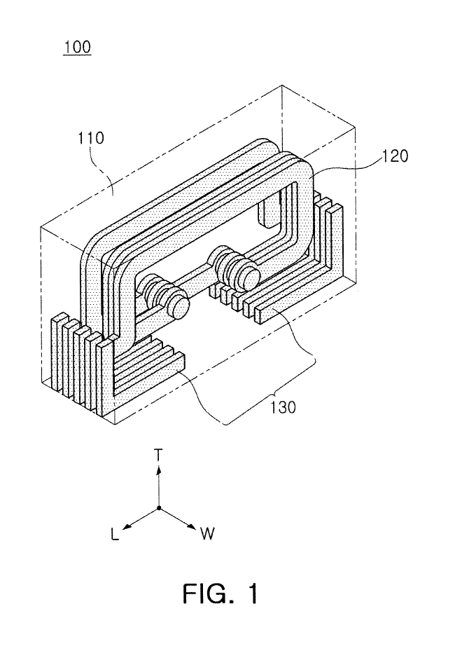

FIG. 1 is a perspective view illustrating a chip component 100 according to an exemplary embodiment of the present disclosure such that an internal coil unit 120 appears.

Referring to FIG. 1, the chip component 100 according to an exemplary embodiment of the present disclosure may include a ceramic body 110, the internal coil unit 120, and external electrodes 130.

The ceramic body 110 may be formed by stacking a plurality of ceramic layers having a plurality of through holes. Also, the plurality of ceramic layers forming the ceramic body 110 may be in a sintered state and may each be integrated such that boundaries therebetween may not be readily apparent without using a scanning electron microscope (SEM).

The ceramic body 110 may have a hexahedral shape, for example. In order to clarify the present exemplary embodiment, L, W, and T, defining directions of a hexahedron (six-sided object) shown in FIG. 1, indicate a length direction, a width direction, and a thickness direction, respectively.

Also, the ceramic body 110 may have a lower surface provided as a mounting surface, an upper surface opposing the lower surface, both side surfaces in the length direction, and both side surfaces in the width direction.

The plurality of ceramic layers may include known dielectric material and ferrite such as an Al₂O₃-based dielectric material, Mn—Zn-based ferrite, Ni—Zn-based ferrite, Ni—Zn—Cu-based ferrite, Mn—Mg-based ferrite, Ba-based ferrite, and Li-based ferrite.

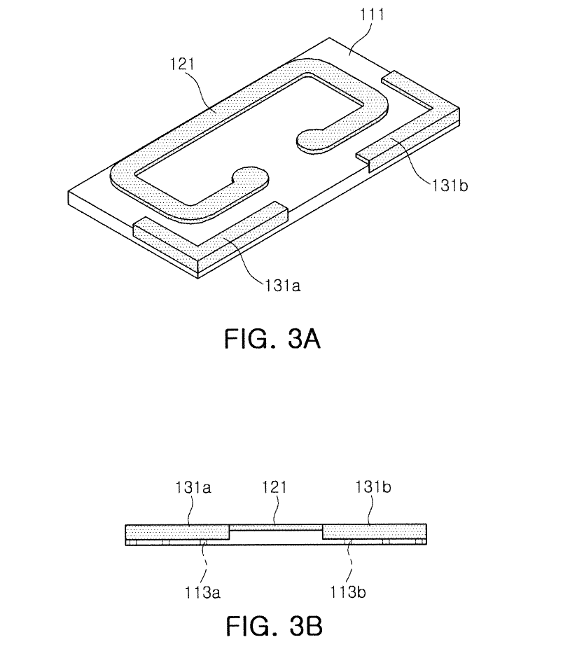

The internal coil unit may be positioned within the ceramic body 110. Also, the internal coil unit may include an internal conductive pattern 121 (FIG. 3A) disposed on the plurality of ceramic layers.

The ceramic body 110 may be formed by stacking the plurality of ceramic layers with the internal conductive pattern 121 (FIG. 3A) formed thereon, and the internal conductive pattern 121 (FIG. 3A) may form the internal coil unit within the ceramic body 110.

The internal coil unit may be disposed to be perpendicular with respect to a lower surface of the ceramic body 110 within the ceramic body 110.

Namely, the internal coil unit 120 disposed within the ceramic body 110 may be disposed such that a virtual central axis penetrating through the center of the internal coil unit 120 is parallel to an upper surface or the lower surface of the ceramic body 110 in the thickness direction.

The internal conductive patterns 121 (FIG. 3) formed on the plurality of ceramic layers may be electrically connected to each other by vias to form a single internal coil unit 120, thus realizing intended inductance.

The internal coil unit 120 may be formed by printing conductive paste including a conductive metal. The conductive metal is not particularly limited as long as a metal has excellent electrical conductivity, and for example, the conductive metal may be silver (Ag), palladium (Pd), aluminum (Al), nickel (Ni), titanium (Ti), gold (Au), copper (Cu), or platinum (Pt) alone or any mixture thereof.

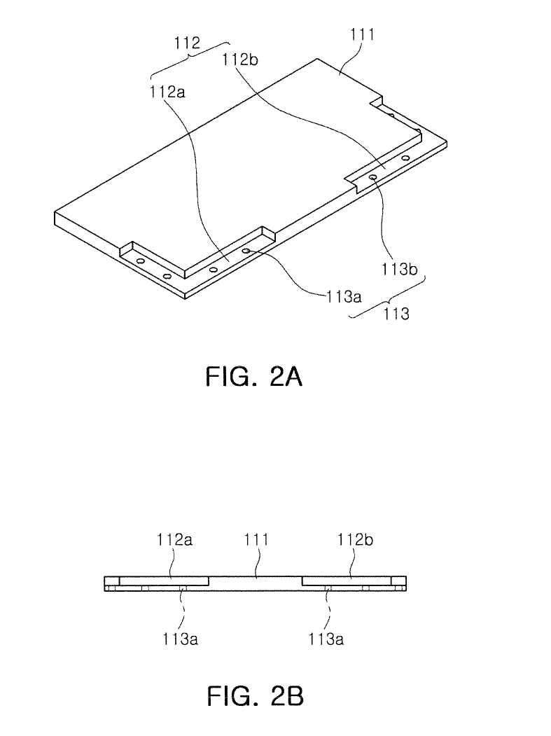

FIGS. 2A and 2B are views illustrating a ceramic layer 111 having intagliated recess portions 112, among components of the chip component 100 according to an exemplary embodiment of the present disclosure.

Referring to FIGS. 2A and 2B, the ceramic layer 111 may include intagliated recess portions 112a and 112b (denoted by 112 when commonly referred to).

In an exemplary embodiment, the intagliated recess portions 112 may be formed by intagliating the ceramic layer 111 from one surface thereof to the other surface thereof opposing the one surface. Here, in FIG. 2A, it is illustrated that the ceramic layer 111 is intagliated from an upper surface thereof to a lower surface thereof to a predetermined depth.

That is, the intagliated recess portions 112 may be formed to be concave in a thickness direction of the ceramic layer 111 with respect to the overall thickness of the ceramic layer 111 such that a depth of the intagliated recess portion 112 are less than a thickness of the ceramic layer 111. The number, thicknesses, and positions of the external electrode patterns 112 may be common to the plurality of ceramic layers disposed in the ceramic body 110, and may be adjusted depending on an intended inductance value.

In particular, shapes of the intagliated recess portions 112 may vary according to positions in which the external electrodes 130 are formed in the ceramic body 110.

That is, in a case in which the external electrodes 130 are formed on both side surfaces of the ceramic body 110 in the length direction, the intagliated recess portions 112 may be positioned on both side surfaces of the ceramic layer 111 in the length direction.

In FIGS. 2A and 2B, it is illustrated that the intagliated recess portions 112a and 112b are provided at corners of both sides of the ceramic layer 111 in the length direction and have an “L” shape, and thus, the external electrodes 130 (please refer to FIG. 1) may have an “L” shape.

One or more via holes 113 penetrating through the ceramic layer 111 vertically may be formed in the intagliated recess portions 112 of the ceramic layer 111, and may be filled with a conductive material to form vias. The number and shape of the via holes 113 may not be limited to those illustrated in FIGS. 2A and 2B, but the same number of via holes having the same shape may be formed on each ceramic layer 111 in which the intagliated recess portions 112 are positioned (i.e., each ceramic layer 111 may have the same number of via holes having the same shape).

FIGS. 3A and 3B are views illustrating a ceramic layer illustrated in FIGS. 2A and 2B having an internal conductive pattern and a conductive material.

Referring to FIGS. 2A, 2B, 3A, and 3B, the ceramic layer 111 may further include a conductive material filling the intagliated recess portions 112. Here, the conductive material may include silver (Ag), silver-palladium (Ag-Pd), nickel (Ni), copper (Cu), and the like.

The ceramic body 110 may be formed by stacking a plurality of ceramic layers 111. In this case, external electrode patterns 131a and 131b filled with the conductive material may be electrically connected through one or more via holes 113a and 113b formed in the ceramic layer 111, and the external electrode patterns 131a and 131b may be stacked in a stacking direction to form the external electrodes 130 having the “L” shape.

In detail, a plating layer may be formed on the external electrode patterns 131a and 131b formed by plating a conductive material such as Cu/Ni/Sn or NI/Sn, and the plating layers may be surface-connected to each other to form the external electrodes 130.

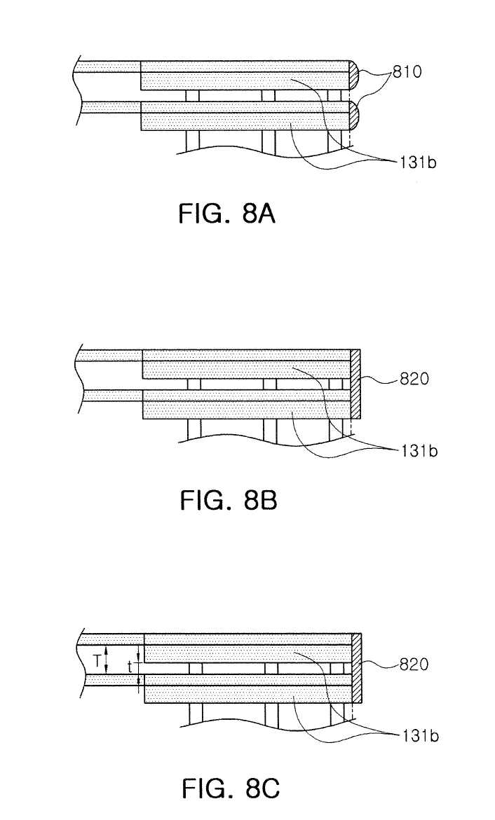

The formation of the external electrodes 130 using the external electrode patterns 131a and 131b will be described in detail with reference to FIG. 8 hereinafter.

Thicknesses of the external electrode patterns 131a and 131b may be equal to the thickness of the ceramic layer 111 or may be formed to exceed the thickness of the ceramic layer 111 so as to be equal through shrinkage after sintering.

The internal conductive pattern 121 may be disposed on the ceramic layer 111. The shape of the internal conductive pattern 121 may vary depending on intended inductance and not limited to the shape illustrated in FIG. 3A.

The internal conductive patterns 121 formed on the plurality of ceramic layers 111 may be electrically connected through the vias. That is, the internal conductive patterns 121 formed on the plurality of ceramic layers 111 may be electrically connected to each other and may continuously overlap in the stacking direction to form the internal coil unit 120 (please refer to FIG. 1) having a spiral structure.

Referring to FIG. 3B, when a surface of the ceramic layer 111 to which the internal conductive pattern 121 is exposed to the outside is an upper surface of the ceramic layer 111, the internal conductive pattern 121 and the external electrode patterns 131a and 131b may be substantially coplanar on the upper surface of the ceramic layer 111, but the present inventive concept is not limited thereto.

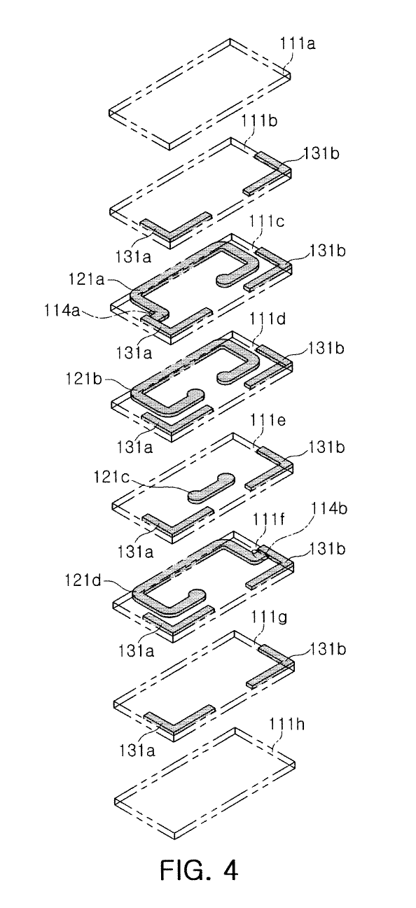

FIG. 4 is an exploded perspective view illustrating the chip component illustrated in FIG. 1.

Referring to FIG. 4, the chip component 100 according to an exemplary embodiment of the present disclosure may include a plurality of ceramic layers 111a to 111h forming the ceramic body 110.

Here, the plurality of ceramic layers 111a to 111h forming the ceramic body 110 may include ceramic layers 111a and 111h without external electrode patterns 131a and 131b. Namely, the ceramic layers 111a and 111h may serve as protective layers protecting the interior of the ceramic body 110.

Also, the plurality of ceramic layers 111a to 111h may include the ceramic layers 111b and 111g on which the internal conductive patterns 121a to 121d are not formed thereon.

In FIG. 4, it is illustrated that the ceramic body 110 includes two ceramic layers 111a and 111h on which the external electrode patterns 131a and 131b are not formed, but the number of stacked ceramic layers is not limited thereto and may vary depending on intended inductance.

Also, in FIG. 4, it is illustrated that the internal conductive patterns 121a to 121d are formed only on the ceramic layers 111c to 111f, but the present inventive concept is not limited thereto.

The internal conductive patterns 121a to 121d may be formed on the ceramic layers 111c to 111f and may be electrically connected to each other by a plurality of vias (not shown) in a stacking direction of the ceramic body 110 to form the internal coil unit 120 (please refer to FIG. 1)

The internal conductive patterns 121a and 121d may include lead-out portions 114a and 114b exposed to the outside of the ceramic body 110, respectively. The lead-out portions 114a and 114b may be disposed to be spaced apart from one another in the mutually opposite directions on both side surfaces of the ceramic layers 111c and 111f in a length direction, and may be electrically connected to the external electrode patterns 131a and 131b, respectively.

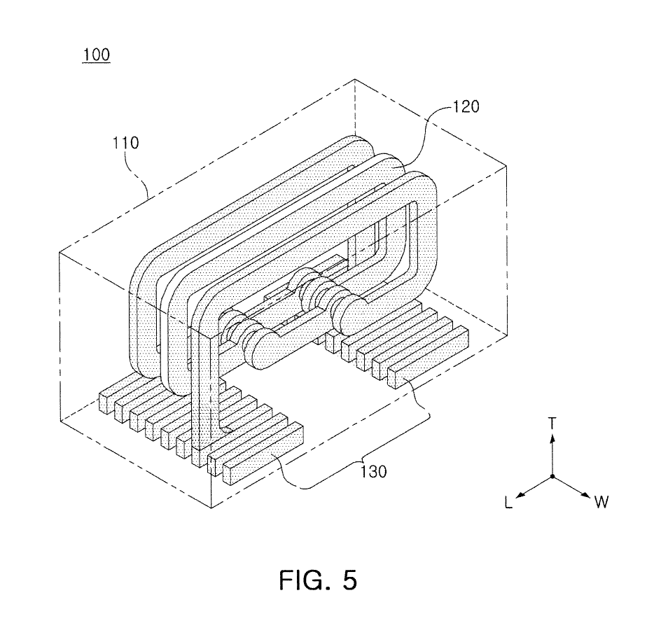

FIG. 5 is a perspective view illustrating a chip component 100 according to another exemplary embodiment of the present disclosure such that an internal coil unit 120 appears.

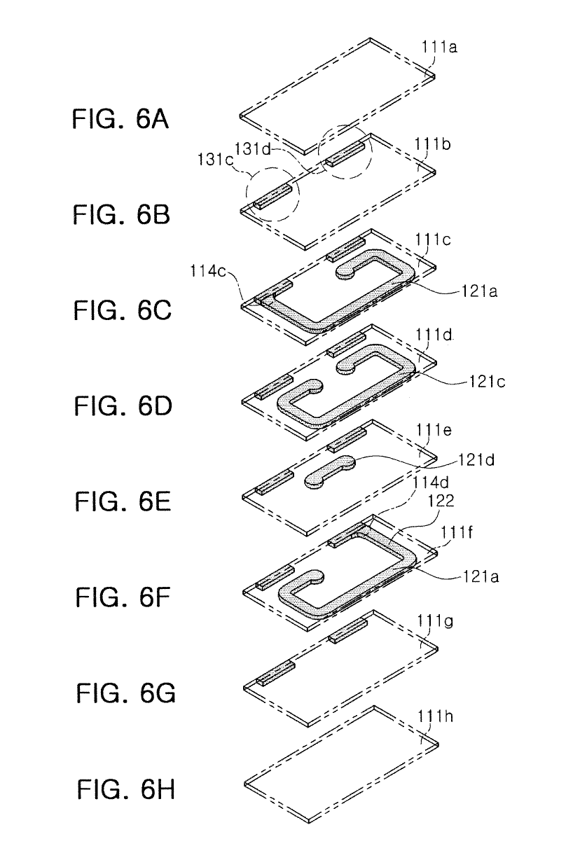

FIG. 6 is an exploded perspective view of the chip component 100 illustrated in FIG. 5.

Referring to FIG. 5, in the chip component 100 according to another exemplary embodiment of the present disclosure, external electrodes 130 may be formed on a lower surface of a ceramic body 110.

Referring to FIG. 6, in an exemplary embodiment, the external electrode patterns 131c and 131d formed by filling intagliated recess portions with a conductive material may be formed by intagliating the ceramic layer 111 from one surface thereof to the other surface thereof opposing the one surface. Here, thicknesses and positions of the external electrode patterns 131c and 131d are the same as those of the external electrode patterns 131a and 131b according to the exemplary embodiment described above, and thus, a description thereof will be omitted.

However, the shapes of the external electrode patterns 131c and 131d may vary according to positions in which the external electrodes 130 (please refer to FIG. 5) are formed on the ceramic body 110.

That is, among the components of the chip component 100 according to another exemplary embodiment of the present disclosure, external electrodes 130 have a lower electrode form, and thus, the external electrode patterns 131c and 131d may be formed by charging a conductive material on one side surface of the ceramic layer 111 in the width direction.

Referring to FIG. 6, unlike those illustrated in FIG. 4, lead-out portions 114c and 114d included in the internal conductive patterns 121a and 121d may be electrically connected to the external electrode patterns 131c and 131d so as to be exposed to a lower surface provided as a mounting surface of the ceramic body 110.

That is, the lead-out portions 114c and 114d may be exposed to one side surface (lower surface of the ceramic body when the ceramic layers are stacked) of each of the ceramic layers 111c and 111f in the width direction. Also, the lead-out portions 114c and 114d may respectively be connected to the external electrode patterns 131c and 131d disposed to be spaced apart from one another by a predetermined distance.

In addition to the foregoing contents, the ceramic layers 111a to 111h, a type of the conductive material, the internal conductive patterns 121a to 121d, and vias are the same as those of the exemplary embodiment of the present disclosure described above, and thus, descriptions thereof will be omitted.

### Method for Manufacturing Chip Component

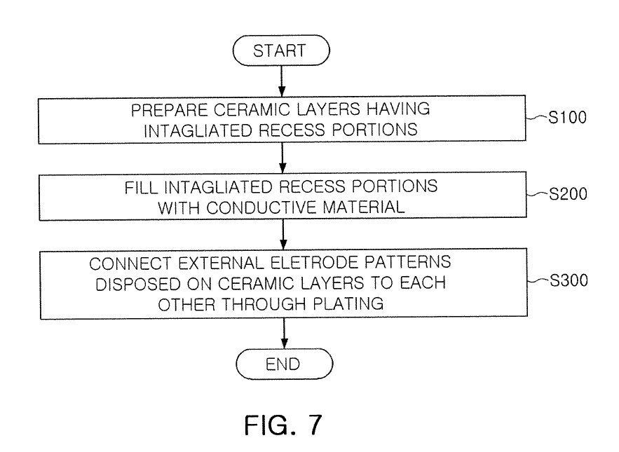

FIG. 7 is a flowchart illustrating a method for manufacturing a chip component according to an exemplary embodiment of the present disclosure.

Referring to FIGS. 4 and 7, a method for manufacturing a chip component according to an exemplary embodiment of the present disclosure may include an operation (S100) of preparing a plurality of ceramic layers 111b to 111g each having intagliated recess portions 112a and 112b, an operation (S200) of filling the intagliated recess portions 112a and 112b with a conductive material, and an operation (S300) of connecting the external electrode patterns 131a and 131b filled with a conductive material disposed on the plurality of ceramic layers 111b to 111g to each other through plating to form external electrodes 130.

The intagliated recess portions 112a and 112b may be formed by intagliating the ceramic layer from one surface thereof to the other surface thereof opposing the one surface, and the depths of the intagliated recess portions 112a and 112b are less than the thickness of the ceramic layer. Also, the thicknesses, shapes, and the like, of the intagliated recess portions 112a and 112b may be uniformly maintained in the entirety of the stacked ceramic layers and may vary depending on intended inductance.

Also, in an exemplary embodiment, the intagliated recess portions 112a and 112b may be formed through laser beam machining. That is, a laser beam may be irradiated to a surface of an object, and the vicinity of the surface of the object may be melted and evaporated to remove a material, thus performing laser beam machining.

Thereafter, the intagliated recess portions 112a and 112b may be filled with a conductive material using a method such as screen printing, or the like, to form external electrode patterns 131a and 131b.

Here, the plurality of ceramic layers 111a to 111h may be disposed to be perpendicular to a lower surface provided as a mounting surface of the ceramic body 110.

Meanwhile, the method for manufacturing a chip component may further include an operation of forming internal conductive patterns 121a to 121d on the ceramic layers 111c to 111g and an operation of stacking the ceramic layers with the internal conductive patterns 121a to 121d formed thereon to form the ceramic body 110.

That is, the plurality of ceramic layers may include ceramic layers 111b and 111g on which the internal conductive patterns 121a to 121d are not formed.

Here, it is illustrated and described that the ceramic body 110 includes two ceramic layers 111a and 111h on which the external electrode patterns 131a and 131b are not formed, but the number of stacked ceramic layers is not limited thereto and may vary depending on intended inductance.

Also, the method for manufacturing a chip component may further include an operation of forming one or more via holes on the ceramic layers 111b to 111g having the intagliated recess portions 112a and 112b. The intagliated recess portions 112a and 112b formed on the plurality of ceramic layers 111b to 111g may be electrically connected to each other through the vias.

Here, the operation of forming the internal conductive patterns 121a to 121d on the ceramic layers 111c to 111f and the operation of forming one or more via holes on the ceramic layers 111b to 111g having the intagliated recess portions 112a and 112b may be interchanged in order.

Various chip components may be manufactured by adjusting shapes, positions, and stacking order of the intagliated recess portions 112a and 112b, the via holes, the internal conductive patterns 121a to 121d.

FIG. 8 is a view specifically illustrating a method for forming external electrodes in a method for manufacturing the chip component illustrated in FIG. 7.

Referring to FIG. 8 (a), a plating layer 810 may be formed on the external electrode patterns 131b (the same with 131a) through plating such as Cu/Ni/Sn or Ni/Sn and the plating layers 810 may be surface-connected to each other to form an external electrode 820.

That is, by forming the external electrode patterns 131b exposed to the outside using an intaglio printing method, a large contact surface may be obtained between the plating layers 810, preventing a phenomenon in which partial plating is cut off. Also, the plating layers 810 may be stably connected and defective solderability may be improved.

Referring to FIG. 8(c), a thickness t of the ceramic layer in the intagliated portion over a thickness T of an interlayer ceramic layer of the internal coil pattern may satisfy T/5<t<T/2.

Here, when T/5>=t, after the intagliated portions of the ceramic layer are filled with a conductive material and the ceramic layers are stacked in order, a corresponding portion may be torn due to a difference in strength of the ceramic sheets resulting from the difference between the thicknesses T and t.

Also, when t>=T/2, it may be difficult to smoothly connect the ceramic interlayer plating layers, having a high possibility of generating variations in thicknesses partially, and in a severe case, the plating layers may be minutely broken, rather than being connected, and it may be difficult to discover the broken portion.

In the method for manufacturing the chip component 100 according to exemplary embodiments of the present disclosure, since the external electrodes are formed simultaneously when ceramic layers are stacked without an extra process to form external electrodes, a process of forming a marking pattern to indicate a direction of internal coil patterns may be omitted.

As set forth above, in the chip component and the manufacturing method thereof according to exemplary embodiments of the present disclosure, the external electrodes may be formed simultaneously when the ceramic layers are stacked without having to perform an extra process to form the external electrodes, and thus, manufacturing processes may be simplified.

While exemplary embodiments have been shown and described above, it will be apparent to those skilled in the art that modifications and variations could be made without departing from the scope of the present invention as defined by the appended claims.

What is claimed is:

1. A chip component comprising:
a ceramic body including a plurality of ceramic layers, each of which including external electrode patterns provided by filling intagliated recess portions with a conductive material, the intagliated recess portions being disposed to be spaced apart from one another;
an internal coil unit positioned within the ceramic body and including internal conductive patterns disposed on the plurality of ceramic layers; and
external electrodes, each of which is provided by connecting the external electrode patterns to each other.

2. The chip component of claim 1, wherein the external electrode patterns are connected through one or more vias penetrating through the plurality of ceramic layers having the external electrode patterns.

3. The chip component of claim 1, wherein the internal conductive patterns include lead-out portions exposed to the exterior of the ceramic body.

4. The chip component of claim 3, wherein the lead-out portions are exposed to a lower surface of the ceramic body provided as a mounting surface of the ceramic body, and the external electrodes are disposed on the lower surface of the ceramic body and connected to the lead-out portions.

5. The chip component of claim 3, wherein the lead-out portions are exposed to both end surfaces of the ceramic body in a length direction of the ceramic body, and
the external electrodes are disposed on the end surfaces of the ceramic body in the length direction.

6. The chip component of claim 1, wherein the plurality of ceramic layers are disposed in a direction perpendicular to the lower surface of the ceramic body provided as a mounting surface of the ceramic body.

7. A chip component comprising:
a ceramic body including a plurality of ceramic layers having intagliated recess portions which are disposed to be spaced apart from one another; and
a conductive material filling the intagliated recess portions,
wherein a depth of each of the intagliated recess portions is less than a thickness of each of the ceramic layers, and
a plurality of external electrode patterns provided by filling the intagliated recess portions with the conductive material are connected through one or more vias penetrating through the plurality of ceramic layers.

8. The chip component of claim 7, wherein the intagliated recess portions are formed by intagliating each of the ceramic layers from one surface thereof to the other surface thereof.

9. The chip component of claim 7, wherein the external electrode patterns are disposed on both ends of the plurality of ceramic layers in a length direction thereof.

10. The chip component of claim 7, further comprising an internal coil unit disposed within the ceramic body and including internal conductive patterns disposed on the plurality of ceramic layers,
wherein the internal conductive patterns have lead-out portions exposed to the exterior of the ceramic body.

11. The chip component of claim 10, wherein at least one of the external electrode patterns is connected to the lead-out portions.

12. The chip component of claim 10, wherein the lead-out portions are exposed to both end surfaces of the ceramic body in a length direction of the ceramic body, and
the external electrode patterns are disposed on both end surfaces of the ceramic body in the length direction of the ceramic body and connected to the lead-out portions.

13. The chip component of claim 1, wherein the plurality of ceramic layers are disposed in a direction perpendicular to a lower surface of the ceramic body provided as a mounting surface of the ceramic body.

14. A method for manufacturing a chip component, the method comprising:
preparing a plurality of ceramic layers having intagliated recess portions which are disposed to be spaced apart from one another;
filling the intagliated recess portions with a conductive material; and
forming a plurality of external electrode patterns by filling the intagliated recess portions disposed on each of the plurality of ceramic layers with a conductive material and connecting the external electrode patterns to each other.

15. The method of claim 14, further comprising:
forming internal conductive patterns on the plurality of ceramic layers; and
stacking the plurality of ceramic layers having the internal conductive patterns formed thereon to form a ceramic body.

16. The method of claim 14, further comprising forming one or more vias in each of the plurality of ceramic layers having the electrode patterns,
wherein the external electrode patterns formed on the plurality of ceramic layers are connected through the vias.

17. The method of claim 14, wherein the plurality of ceramic layers are disposed in a direction perpendicular to a lower surface of the ceramic body provided as a mounting surface of the ceramic body.

18. The method of claim 14, wherein the external electrode patterns are intagliated from one surface of each of the ceramic layers to the other surface thereof, and
thicknesses of the external electrode patterns are less than the thicknesses of the plurality of ceramic layers.

19. The method of claim 14, wherein, in the connecting of the external electrode patterns, the external electrode patterns are surface-connected through plating to form external electrodes.
